(19) United States
(12) Patent Application Publication
(10) Pub. No.: US 2025/0004130 A1
(43) Pub. Date: Jan. 2, 2025

(54) OBJECT DETECTION DEVICE FOR A VEHICLE

(71) Applicant: TOYOTA JIDOSHA KABUSHIKI KAISHA, Toyota-shi (JP)

(72) Inventor: Atsutoshi SAKAGUCHI, Toyota-shi (JP)

(73) Assignee: TOYOTA JIDOSHA KABUSHIKI KAISHA, Toyota-shi (JP)

(21) Appl. No.: 18/739,795

(22) Filed: Jun. 11, 2024

(30) Foreign Application Priority Data
Jun. 30, 2023 (JP) 2023-108050

(51) Int. Cl. G01S 15/931; G01S 7/534

(52) U.S. Cl. CPC G01S 15/931; G01S 7/534

(57) ABSTRACT

A object detection device for a vehicle, in which sonars A and C simultaneously transmit sound waves and receive direct waves reflected by objects; a sonar B positioned between the sonars A and C receives indirect waves reflected by the objects; and, when, in a situation where the sonars A and C receive the direct waves and the sonar B receives one indirect wave, a peak value of the indirect wave received by the sonar B is greater than or equal to a predetermined multiplication with respect to peak values of the direct waves received by the sonars A and C, an electronic control unit estimates positions of the objects in detection areas of the sonars A and C based on a flight time of the direct waves received by the sonars A and C, respectively and a flight time of the indirect wave received by the sonar B.

### CROSS-REFERENCE TO RELATED APPLICATION

This application claims priority to Japanese Patent Application No. JP2023-108050 filed on Jun. 30, 2023, the content of which is hereby incorporated by reference in its entirety into this application.

### BACKGROUND

### 1. Technical Field

The present disclosure relates to an object detection device for a vehicle such as an automobile.

### 2. Description of the Related Art

An object detection device for a vehicle such as an automobile includes at least two sonars and a control unit that controls the sonars. A direct wave, which is an ultrasonic wave transmitted by one sonar and reflected by an object, is received by the one sonar, and an indirect wave, which is the ultrasonic wave reflected by the object, is received by the other sonar. The control unit estimates a position of the object that generated the direct wave and the indirect wave by reflection, ie, a distance between the object and the vehicle and a direction of the object with respect to the vehicle, based on flight times of the direct wave and the indirect wave.

When a plurality of reflected waves are generated by reflection by an objects and the plurality of the reflected waves overlap with each other out of phase, a peak value of the indirect waves become low due to cancellation of the reflected waves, making it impossible to detect the objects. As an object detection device that addresses this problem, for example, Japanese Patent Application Laid-open No. 2022-124823 describes an object detection device that improves code identification performance of reflected waves by means of an ultrasonic wave encoded by frequency modulation and pulse compression processing.

In order to widen object detection range and increase object detection efficiency, it is conceivable that at least three sonars are installed, and two sonars simultaneously transmit ultrasonic waves and receive direct waves, while the remaining sonar receives indirect waves.

However, when flight times of the two ultrasonic waves transmitted by two sonars and received by the remaining sonar as indirect waves are the same, and the phases of the two indirect waves received by the remaining sonar are in phase or nearly in phase, the two indirect waves reinforce each other. Therefore, two indirect waves are received by the remaining sonar as only one indirect wave, so that even if there are two objects to be detected, a position of only one object may be detected. Conventional object detection devices such as the object detection device described in the Japanese Patent Application Laid-open Publication cannot solve the above problem caused by the reinforcement of two indirect waves.

### SUMMARY

The present disclosure provides an object detection device which is improved to, in a situation where there are two objects to be detected, estimate positions of the two objects even if indirect waves, which are waves simultaneously transmitted by two sonar and reflected by the two objects, reinforce each other.

According to the present disclosure, an object detection device for a vehicle is provided which comprises first to third sonars arranged spaced from each other on an outer periphery of the vehicle with the third sonar being located between the first and second sonars, and a control unit for controlling the first to third sonars; the first and second sonars are configured to simultaneously transmit sound waves and receive direct waves that are sound waves reflected by objects; the third sonar is configured to receive indirect waves that are sound waves transmitted by the first and second sonars and reflected by the objects; and the control unit is configured to estimate positions of the objects that generate the direct waves and the indirect waves by reflection of the sound waves based on flight times of the direct waves and the indirect waves.

The control unit is configured to, when, in a situation where the first and second sonars receive the direct waves and the third sonar receives one indirect wave, a peak value of the indirect wave received by the third sonar is greater than or equal to a predetermined magnification with respect to peak values of the direct waves received by the first and second sonars, estimate a position of an object existing in a detection area by the direct wave received by the first sonar based on the flight time of the direct wave received by the first sonar and the flight time of the indirect wave received by the third sonar, and estimate a position of an object existing in a detection area by the direct wave received by the second sonar based on the flight time of the direct wave received by the second sonar and the flight time of the indirect wave received by the third sonar.

According to the above configuration, when, in a situation where the first and second sonar receive the direct waves and the third sonar receives one indirect wave, a peak value of the indirect wave received by the third sonar is greater than or equal to a predetermined magnification with respect to peak values of the direct waves received by the first and second sonars, positions of the objects are estimated as follows. That is, a position of an object existing in a detection area by the direct wave received by the first sonar is estimated based on the flight time of the direct wave received by the first sonar and the flight time of the indirect wave received by the third sonar. Further, a position of an object existing in a detection area by the direct wave received by the second sonar is estimated based on the flight time of the direct wave received by the second sonar and the flight time of the indirect wave received by the third sonar.

Therefore, in a situation where there are two objects to be detected, even if the indirect waves, which are sound waves simultaneously transmitted by the first and second sonars and received by the third sonar, become one indirect wave by reinforcing each other, positions of two objects can be estimated.

In one aspect of the present disclosure, the control unit is configured to estimate a sonar corresponding to the indirect wave received by the third sonar among the first and second sonars, and estimate a position of the object existing in the detection area by the direct wave received by the estimated sonar based on the flight time of the direct wave received by the estimated sonar and the flight time of the indirect wave received by the third sonar.

In another aspect of the present disclosure, the first and second sonars are configured to transmit sound waves encoded in different codes by frequency modulation, and the control unit is configured to estimate a sonar corresponding to the indirect wave received by the third sonar based on the code of the indirect wave received by the third sonar.

Further, in another aspect of the present disclosure, the control unit is configured to, when only one of the first and second sonars receives the direct wave and the third sonar receives the indirect wave, estimate a position of the object existing in the detection area by the direct wave received by the one of the first and second sonars based on the flight time of the direct wave received by the one of the first and second sonars and the flight time of the indirect wave received by the third sonar.

Further, in another aspect of the present disclosure, with a range where the detection area by the direct wave received by the first sonar and a detection area by the indirect wave received by the third sonar overlap being defined as an overlapping range, and a ratio of a distance between an arbitrary point existing in the overlapping range and the third sonar to a distance between the arbitrary point and the first sonar being defined as a predetermined ratio, the predetermined magnification is a maximum value of the predetermined ratio.

Other objects, other features and attendant advantages of the present disclosure will be readily understood from the description of the embodiments of the present disclosure described with reference to the following drawings.

### BRIEF DESCRIPTION OF THE DRAWINGS

FIG. 1 is a schematic configuration diagram showing an object detection device according to an embodiment of the present disclosure.

FIG. 2 is a diagram showing the order of operation of sonars A to D on the front end side in the embodiment.

FIG. 3A is a diagram showing a situation in which indirect waves reinforce each other in a case of two obstacles.

FIG. 3B is a diagram showing a situation in which indirect waves reinforce each other in a case of one obstacle.

FIG. 4A is a diagram showing a peak value of a voltage of an indirect wave.

FIG. 4B is a diagram showing a peak value of a voltage of another indirect wave.

FIG. 4C is a diagram showing a peak value of a voltage when the indirect waves reinforce each other.

FIG. 5X1 is a diagram showing Case 1 where indirect waves of ultrasonic waves transmitted simultaneously by sonars A and C reinforce each other.

FIG. 5X2 is a diagram showing Case 2 where only one indirect wave of ultrasonic wave transmitted by one of sonars A and C is received by sonar B.

FIG. 6 is a flowchart showing the first half of an object detection control routine of the embodiment.

FIG. 7 is a flowchart showing the second half of the object detection control routine of the embodiment.

### DESCRIPTION OF THE PREFERRED EMBODIMENT

An object detection device according to an embodiment of the present disclosure will be described in detail below with reference to the accompanying drawings.

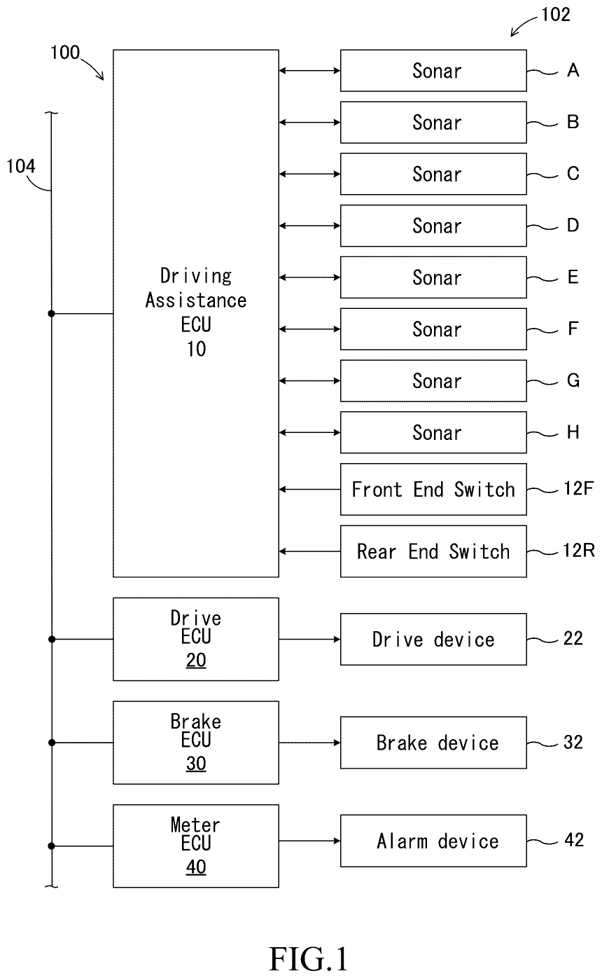

As shown in FIG. 1, the object detection device 100 according to the embodiment of the present disclosure is applied to a vehicle 102 and includes a driving assistance ECU 10. The vehicle 102 may be a vehicle capable of automatic driving, and includes a drive ECU 20, a brake ECU 30, and a meter ECU 40. ECU means an electronic control unit that includes a microcomputer as a main part.

The microcomputer of each ECU includes a CPU, a ROM, a RAM, a readable/writable nonvolatile memory (N/M), an interface (I/F), and the like. Each CPU implements various functions by executing instructions (programs, routines) stored in the ROM. Furthermore, these ECUs are connected to each other via a CAN (Controller Area Network) 104 so that data can be exchanged (communicated). Therefore, the detected values of sensors (including switches) connected to a specific ECU are also transmitted to other ECUs.

The driving assistance ECU 10 detects objects such as walls, guardrails, and other vehicles around the vehicle 102, and estimates the position of the object, that is, the distance between the object and the vehicle and the direction of the object with respect to the vehicle. In the embodiment, when the driving assistance ECU 10 cooperates with other ECUs and determines that the vehicle has come too close to the object, it issues an alarm indicating this, and adjusts the driving force and power of the vehicle 102 as necessary. By controlling the braking force, the vehicle is prevented from colliding with the object.

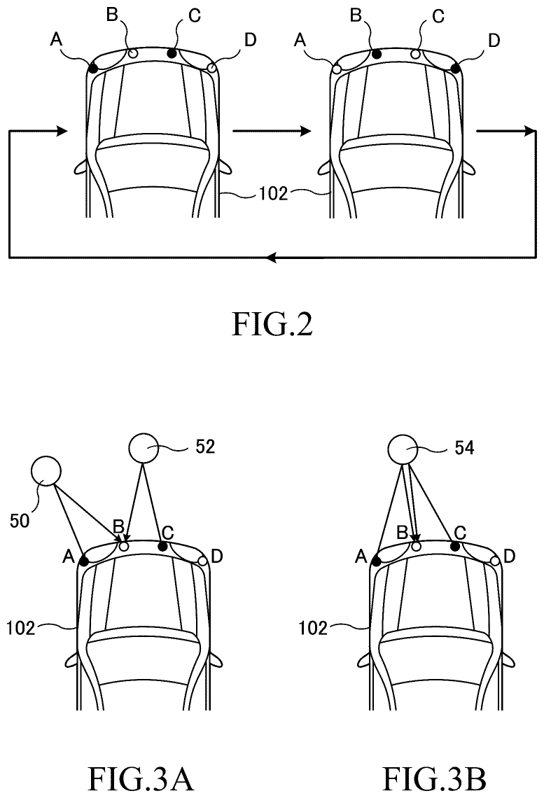

Sonars A to D and sonars E to H are connected to the driving assistance ECU 10, and these sonars are controlled by the driving assistance ECU 10. As shown in FIG. 2, the sonars A to D are disposed on an outer periphery of a front end of the vehicle 102. The sonar B is located between the sonars A and C, and the sonar C is located between the sonars B and D. Although not shown in the figure, the sonars E to H are disposed on an outer periphery of a rear end of the vehicle 102. The sonar F is located between the sonars E and G, and the sonar G is located between the sonars F and H.

Further, the driving assistance ECU 10 is connected to a front end switch 12F and a rear end switch 12R. The driving assistance ECU 10 controls the front end sonars A to D when the front end switch 12F is on, and controls the rear end sonars E to H when the rear end switch 12R is on. Note that the front end switch 12F and the rear end switch 12R may be integrated into one switch. In that case, when the switch is turned on, the driving assistance ECU 10 controls the front end sonars A to D and the rear end sonars E to H.

Each sonar is configured to transmit an ultrasonic wave in a direction away from the vehicle 102, receive the ultrasonic wave transmitted by its own sonar and reflected by an object, that is, a direct wave, and receive ultrasonic waves transmitted by other sonars and reflected by the object, that is, indirect waves. Further, each sonar is configured to output a signal indicating a peak value of a received voltage corresponding to the received ultrasonic wave, and thus a signal indicating the peak value of the received ultrasonic wave to the driving assistance ECU 10.

The driving assistance ECU 10 determines that a sonar is receiving an ultrasonic wave when a wave height value is greater than or equal to a reference value. Therefore, the driving assistance ECU 10 can clearly determine whether or not the sonar is receiving an ultrasonic wave. Further, the driving assistance ECU 10 estimates a distance between an object that reflects a direct wave and an indirect wave and the vehicle 102 and a direction of the object with respect to the vehicle based on flight times of the direct wave and the indirect wave.

In the embodiment, in order to increase object detection efficiency, the driving assistance ECU 10 controls the sonars so that two sonars transmit ultrasonic waves of different frequencies at the same time in both of the sonar group A to D on the front end side and the sonar group E to H on the rear end side. An operation mode in which two sonars simultaneously transmit ultrasonic wave is called dual mode, and an operation mode in which only one sonar transmits an ultrasonic wave is called single mode. When the operation mode is the dual mode, as a means for a sonar receiving the indirect wave to determine whether the indirect wave is the indirect wave of the ultrasonic wave transmitted by which sonar, any means known in the art may be employed, other than varying the frequencies of the ultrasonic waves by encoding them into different codes by frequency modulation.

In particular, in the embodiment, as shown in FIG. 2, when the front end switch 12F is on, the driving assistance ECU 10 controls the front end sonars A to D so that the first and second wave transmission/reception modes are alternately repeated. In the first transmission/reception mode, the sonars A and C simultaneously transmit ultrasonic waves and receive direct waves as the first and second sonars, respectively, and the sonars B and D receive indirect waves. The sonar B functions as the third sonar. In the second transmission/reception mode, the sonars B and D simultaneously transmit ultrasonic waves and receive direct waves as the first and second sonars, respectively, and the sonars A and C receive indirect waves. The sonar C functions as the third sonar.

Similarly, when the rear end switch 12R is on, the driving assistance ECU 10 controls the rear end sonars E to H so that the third and fourth wave transmission/reception modes are alternately repeated. In the third transmission/reception mode, the sonars E and G simultaneously transmit ultrasonic waves and receive direct waves as the first and second sonars, respectively, and the sonars F and H receive indirect waves. The sonar F functions as the third sonar. In the fourth transmission/reception mode, the sonars F and H simultaneously transmit ultrasonic waves and receive direct waves as the first and second sonars, respectively, and the sonars E and G receive indirect waves. The sonar G functions as the third sonar.

In any of the first to fourth transmission/reception modes, the first and second sonars determine whether the ultrasonic wave reflected by an object is a direct wave or an indirect wave based on the frequency of the ultrasonic wave. Further, the third sonar determines, based on the frequency of the received indirect wave, which sonar transmitted the ultrasonic wave that generated the indirect wave.

A drive device 22 that accelerates the vehicle 102 by applying driving force to drive wheels (not shown in FIG. 1) is connected to the drive ECU 20. The drive ECU 20 normally controls the drive device 22 so that the driving force generated by the drive device changes according to a driving operation by a driver, and upon receiving a command signal from the driving assistance ECU 10, controls the drive device 22 based on the command signal.

Note that the drive device 22 is not limited to a combination of an internal combustion engine and an automatic transmission. That is, the drive device 22 may be any drive device known in the art such as a combination of an internal combustion engine and a continuously variable transmission, a so-called hybrid system that is a combination of an internal combustion engine and a motor, a so-called plug-in hybrid system, a combination of a fuel cell and a motor, and a motor or motors, etc.,

A brake device 32 that decelerates the vehicle 102 by applying braking force to wheels not shown in FIG. 1 is connected to the brake ECU 30. The brake ECU 30 normally controls the brake device 32 so that the braking force generated by the brake device changes according to the braking operation by the driver, and upon receiving a command signal from the driving assistance ECU 10, controls the braking force generated by the brake device 32 based on the command signal to control the braking force of each wheel.

An alarm device 42 is connected to the meter ECU 40. The alarm device 42 is activated when it is determined that the vehicle 102 approaches an obstacle excessively and there is a risk of a collision, and issues an alarm, that is, an alarm indicating that the vehicle 102 approaches an obstacle excessively and there is a risk of a collision. The alarm device 42 may be any of an alarm device that issues a visual alarm such as a display or an alarm lamp, an alarm device that issues an auditory alarm such as an alarm buzzer, or an alarm device that issues a tactile alarm such as a vibration of a seat, or any combination thereof.

As described above, the rear end sonars E to H are controlled in the same manner as the front end sonars A to D, so that only the front end sonars A to D will be described.

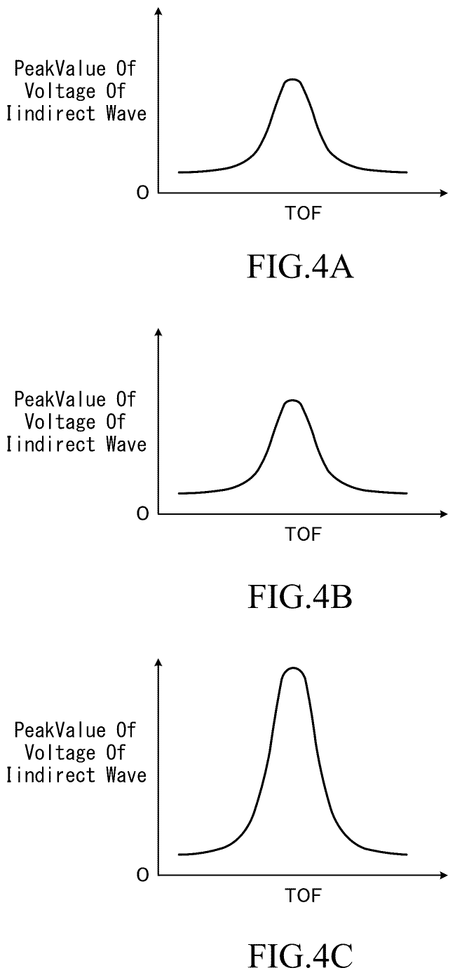

As shown in FIG. 3A, it is assumed that an ultrasonic wave transmitted by the sonar A is reflected by an obstacle 50, and the reflected wave, that is, the indirect wave, is received by the sonar B, and a relationship between a peak value of a voltage of the indirect wave and a TOF (time of flight) is as shown in FIG. 4A. Further, it is assumed that an ultrasonic wave transmitted by the sonar C is reflected by an obstacle 52, and the reflected wave, that is, the indirect wave, is received by the sonar B, and the relationship between a peak value of a received voltage of the indirect wave and the TOF is as shown in FIG. 4B.

When the TOFs at which the wave height values of the indirect waves of the ultrasonic waves simultaneously transmitted by the sonars A and C are the same, and a phase difference between the two indirect waves is 0 degrees or a value close to 0, the two indirect waves reinforce each other. Therefore, a relationship between the peak value of the received voltage of the sonar B and the TOF becomes as shown in FIG. 4C, and it is determined that the sonar B receives only one indirect wave.

If the one indirect wave is estimated to be the indirect wave of the ultrasonic wave transmitted by the sonar A, a position of the obstacle 50 can be estimated by trigonometric calculation based on the TOF of the direct wave received by the sonar A and the TOF of the one indirect wave received by sonar B. However, since it is determined that the sonar B does not receive the indirect wave of the ultrasonic wave transmitted by the sonar C, a position of the obstacle 52 cannot be estimated.

On the other hand, if the one indirect wave is estimated to be the indirect wave of the ultrasonic wave transmitted by the sonar C, the position of the obstacle 52 can be estimated by trigonometric calculation based on the TOF of the direct wave received by the sonar C and the TOF of one indirect wave received by the sonar B. However, since it is determined that the sonar B does not receive the indirect wave of the ultrasonic wave transmitted by the sonar A, the position of the obstacle 50 cannot be estimated.

### PRINCIPLE OF PRESENT INVENTION

A case in which the sonars A and C simultaneously transmit ultrasonic waves and the sonar B receives only one indirect wave is either case 1 or case 2 below.

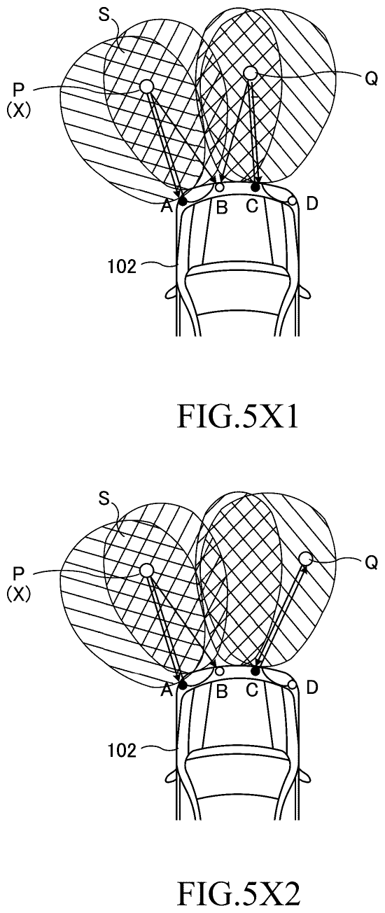

The case 1 is a case in which the indirect waves of the ultrasonic waves simultaneously transmitted by the sonars A and C reinforce each other, and the sonar B receives only one indirect wave (FIG. 5X1).

On the other hand, the case 2 is a case where only the indirect wave of the ultrasonic wave transmitted by one of the sonars A and C is received by the sonar B, and an obstacle that reflects the ultrasonic wave exists outside a detection area of the other of the sonars A and C (FIG. 5X2).

A range in which a detection area by the direct wave received by the sonar A and a detection area by the indirect wave received by the sonar B overlap is defined as a range S. Any point existing within the range S is represented by X, and, as shown in equation (1) below, a ratio of a distance between the point X and the sonar B to a distance between the point X and the sonar A is represented by Ya. For the ultrasonic wave reflected at the point X, a maximum value of a magnification of the peak value of the indirect wave with respect to the peak value of the direct wave is determined in advance as a maximum value Yamax of the ratio Ya, and this is set as a predetermined magnification.

$$Ya = ( a distance between the point X and the sonar B ) \text{} / ( a distance between the point X and the sonar A ) \qquad ( 1 )$$

A case in which the ratios of the peak value of the indirect wave received by the sonar B to the peak value of the direct wave received by the sonar A and the peak value of the direct wave received by the sonar C are both greater than or equal to the predetermined magnification Yamax is determined to be the case 1 instead of the case 2.

In particular, in the embodiment, when the sonars A and C receive direct waves of ultrasonic waves simultaneously transmitted by the sonars A and C, respectively, and the sonar B receives only one indirect wave, it is estimated as follows whether or not two indirect waves have become one indirect wave by reinforcing each other.

When the peak value of the indirect wave received by the sonar B is greater than or equal to the predetermined multiplication Yamax with respect to the peak values of the direct waves received by the sonars A and C, it is determined that reinforcement of the indirect waves has occurred (the case 1). Then, as shown in FIG. 5X1, a position of an obstacle P is estimated based on the TOF of the direct wave received by the sonar A and the TOF of the indirect wave received by the sonar B. Furthermore, a position of an obstacle Q is estimated based on the TOF of the direct wave received by the sonar C and the TOF of the indirect wave received by the sonar B. As shown in FIG. 5X1, the obstacle P exists in the range S. An obstacle Q exists in a range in which a detection area by the direct wave received by the sonar C and a detection area by the indirect wave received by the sonar B overlap.

On the other hand, when the peak value of the indirect wave received by the sonar B is less than the predetermined magnification Yamax with respect to at least one of the peak values of the direct waves received by the sonars A and C, it is determined that no reinforcement of the indirect waves has occurred (the case 2). Then, as shown in FIG. 5X2, it is determined based on the code encoded by frequency modulation which sonar A or C transmitted an ultrasonic wave that generated the indirect wave received by sonar B. Furthermore, a position of the obstacle P is estimated based on the TOF of the direct wave of the determined sonar and the TOF of the indirect wave received by the sonar B.

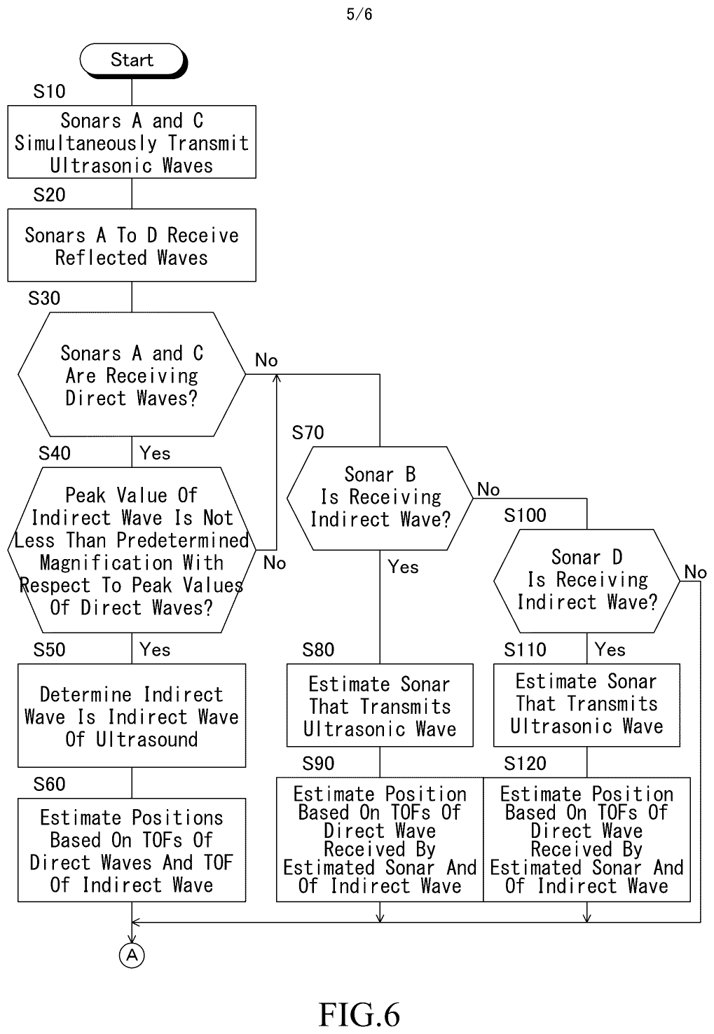

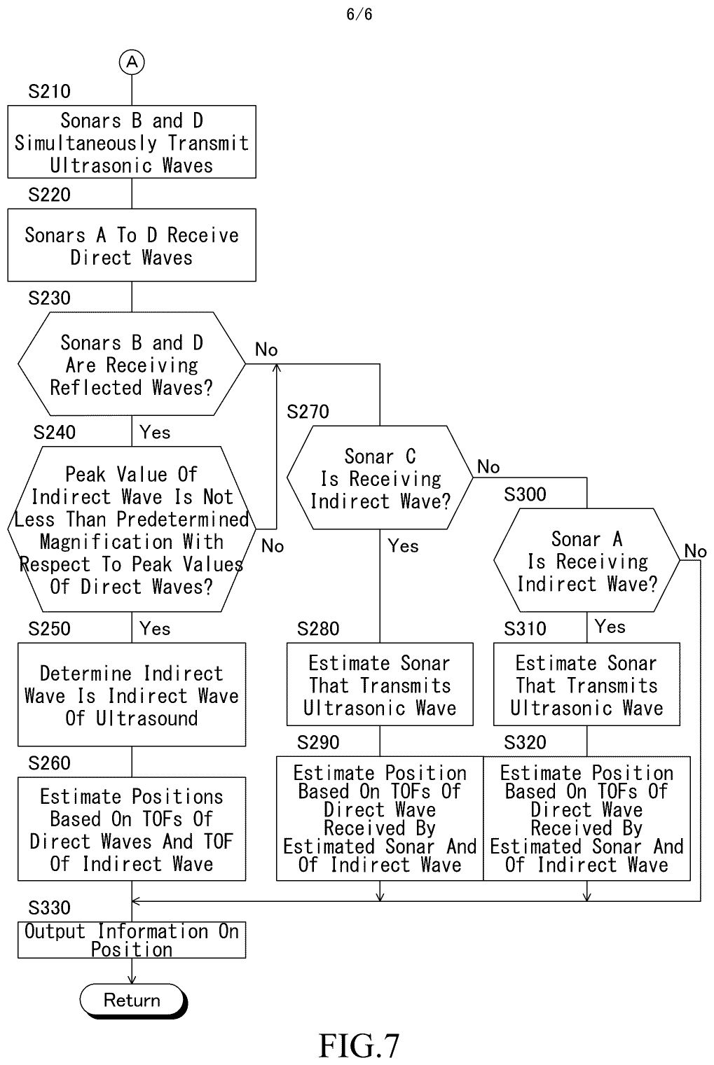

The ROM of the driving assistance ECU 10 stores an obstacle detection control program corresponding to the flowcharts shown in FIGS. 6 and 7 as an embodiment of the object detection control program. The CPU of the driving assistance ECU 10 uses this function in order to solve the problem that when the operation mode is set to the dual mode, indirect waves reinforce each other and a position of one of two obstacles cannot be estimated. Obstacle detection control is executed according to the obstacle detection program.

### <Obstacle Detection Control Program>

Next, the obstacle detection control program in the embodiment will be described with reference to the flowcharts shown in FIGS. 6 and 7. The obstacle detection control according to the flowcharts shown in FIGS. 6 and 7 is repeatedly executed by the CPU of the driving assistance ECU 10 while the front end switch 12F is on. Note that at the start of the obstacle detection control, the operation mode is set to the dual mode.

First, in step S10, the CPU controls the sonars A and C so that the sonars A and C simultaneously transmit ultrasonic waves.

In step S20, the CPU controls the sonars A to D so that the sonars A and C receive direct waves, and the sonars B and D receive indirect waves.

In step S30, the CPU determines whether the sonars A and C are receiving direct waves. When a negative determination is made, that is, when at least one of the sonars A and C is not receiving a direct wave, the control proceeds to step S70, and when an affirmative determination is made, the control proceeds to step S40.

In step S40, the CPU determines whether a peak value of the indirect wave received by the sonar B is greater than or equal to a predetermined magnification Yamax with respect to peak values of the direct waves received by the sonars A and C. When a negative determination is made, that is, when the peak value of the indirect wave received by the sonar B is less than the predetermined magnification Yamax with respect to at least one of the peak values of the direct waves received by the sonars A and C, the control proceeds to step S70. On the other hand, when an affirmative determination is made, the control proceeds to step S50.

In step S50, the CPU determines that the indirect wave received by the sonar B is the indirect waves of the ultrasonic waves transmitted by the sonars A and C, and that the two indirect waves are reinforcing each other.

In step S60, the CPU estimates a position of the obstacle P based on the TOF of the direct wave received by the sonar A and the TOF of the indirect wave received by the sonar B. Further, the CPU estimates a position of the obstacle Q based on the TOF of the direct wave received by the sonar C and the TOF of the indirect wave received by the sonar B.

In step S70, the CPU determines whether the sonar B is receiving an indirect wave. When a negative determination is made, the control proceeds to step S100, and when an affirmative determination is made, the control proceeds to step S80.

In step S80, the CPU estimates, based on the code of the indirect wave that is received by the sonar B, whether the sonar that transmits the ultrasonic wave that generates the indirect wave is the sonar A or the sonar C. Note that when it is determined in step S30 that the sonar C is not receiving the direct wave, it may be estimated that the sonar A is the sonar that transmits the ultrasonic wave that generates the indirect wave.

In step S90, the CPU estimates a position of an obstacle based on the TOF of the direct wave received by the estimated sonar and the TOF of the indirect wave received by the sonar B. For example, when the estimated sonar is the sonar A, the CPU estimates the position of the obstacle based on the TOF of the direct wave received by the sonar A and the TOF of the indirect wave received by the sonar B.

In step S100, the CPU determines whether or not the sonar D is receiving an indirect wave. When a negative determination is made, the control proceeds to step S210, and when an affirmative determination is made, the control proceeds to step S110.

In step S110, the CPU estimates, based on the code of the indirect wave received by the sonar D, whether the sonar that transmits the ultrasonic wave that generates the indirect wave is the sonar A or the sonar C. Note that when it is determined in step S30 that the sonar A is not receiving a direct wave, it may be estimated that the sonar C is the sonar that transmits the ultrasonic wave that generates the indirect wave.

In step S120, the CPU estimates the position of the obstacle based on the TOF of the direct wave received by the estimated sonar and the TOF of the indirect wave received by the sonar B, as in step S90 described above.

Next, the CPU executes steps S210 to S330 shown in FIG. 7. As can be seen from a comparison between FIG. 7 and FIG. 6, steps S210 to S320 are executed similarly to steps S10 to S120, respectively. Therefore, detailed explanation of steps S210 to S320 will be omitted.

Note that in steps S210, S230 to S260, the sonars A and C are replaced by the sonars B and D, respectively and in steps S240 to S260, S270, and S290, the sonar B is replaced by the sonar C. Furthermore, in steps S300 and S320, the sonar D is replaced by the sonar A.

Further, although not shown in the figure, a range in which the detection area by the direct wave received by the sonar B and the detection area by the indirect wave received by the sonar C overlap is defined as the range S. As defined in equation (2) below, any point existing within the range S is defined as X, and the ratio of the distance between the point X and the sonar C to the distance between the point X and the sonar B is defined as Yb. The maximum value Ybmax of the ratio Yb is determined in advance, and this is taken as a predetermined magnification.

$$Yb = ( a distance between the point X and the sonar C ) \text{} / ( a distance between the point X and the sonar B ) \qquad ( 2 )$$

Further, in step S290, the CPU estimates the position of the obstacle based on the TOF of the direct wave received by the sonar estimated in step S280 and the TOF of the indirect wave received by the sonar C.

Further, in step S320, the CPU estimates the position of the obstacle based on the TOF of the direct wave received by the sonar estimated in step S310 and the TOF of the indirect wave received by the sonar A.

When the CPU completes step S260, S290 or S320, in step S330, the CPU outputs the information on the position or positions of the obstacle or obstacles estimated in step S60, S90 or S120 and S260, S290 or S320 for use in collision determination control, warning control, etc., Note that when a negative determination is made in steps S100 and S300, it is considered that there is no obstacle in the detection area of the sonars A to D, so that a signal indicating that the presence or absence of an obstacle could not be determined may be output.

The CPU also determines whether there is a risk that the vehicle 102 will collide with the obstacle or obstacles, in a manner known in the art. When the CPU determines that there is a risk that the vehicle will collide with the obstacle or obstacles, the CPU outputs a command signal to the drive ECU 20 to reduce the output of the drive device 22 to zero, and outputs a command signal to the brake ECU 30 to actuate the brake device 32 to brake the vehicle. Note that the alarm device 42 may be activated, and the reduction of the output of the drive device 22 and/or the braking of the vehicle may be omitted.

### Operation of the Embodiment

As mentioned above, steps S210 to S320 are executed similarly to steps S10 to S120, respectively, so that the operation of the embodiment will be described only with respect to steps S10 to S120.

### C1: When the Sonars a and C are Receiving the Direct Waves and Two Indirect Waves are Reinforcing Each Other

In steps S30 and S40, affirmative determinations are made. Thus, in step S60, the position of the obstacle is estimated based on the TOFs of the direct waves received by the sonars A and C and the TOFs of the indirect waves received by the sonar B. Therefore, even if two obstacles exist and the indirect waves become one due to mutual reinforcement, the positions of the two obstacles can be estimated.

### C2: When the Sonars a and C are Receiving the Direct Waves, but the Two Indirect Waves are not Reinforcing Each Other

In step S30, an affirmative determination is made, but in step S40, a negative determination is made. Therefore, step S70 and the subsequent steps are executed.

### C3: When at Least One of the Sonars a and C is not Receiving the Direct Wave

In step S30, a negative determination is made. Therefore, in this case as well, step S70 and the subsequent steps are executed.

In the case of C2 or C3 above, when the sonar B is receiving the indirect wave, an affirmative determination is made in step S70. Therefore, in step S80, based on the code of the indirect wave received by the sonar B, it is estimated which the sonar A or the sonar C is the sonar that transmitted the ultrasonic wave that generated the indirect wave. Furthermore, in step S90, the position of the obstacle is estimated based on the TOF of the direct wave received by the estimated sonar and the TOF of the indirect wave received by the sonar B.

In the case of C2 or C3 above, when the sonar B is not receiving the indirect wave and the sonar D is receiving the indirect wave, a negative determination is made in step S70, and an affirmative determination is made in step S100. Therefore, in step S110, based on the code of the indirect wave received by the sonar D, it is estimated whether the sonar A or the sonar C is the sonar that transmits the ultrasonic wave that generates the indirect wave. Furthermore, in step S120, the position of the obstacle is estimated based on the TOF of the direct wave received by the estimated sonar and the TOF of the indirect wave received by the sonar B.

Furthermore, in the case of C2 or C3, if the sonars B and D are not receiving the indirect waves, negative determinations are made in steps S70 and S100. Therefore, since it is considered that no obstacle exists in the detection areas of the sonars A to D, the position of the obstacle is not estimated.

In particular, in the embodiment, the maximum values Yamax and Ybmax of the ratios Ya and Yb expressed by equations (1) and (2), respectively, are set as predetermined magnifications. Therefore, when any obstacle exists in the detection areas of the sonars A to D, the position of the obstacle can be estimated.

Note that the reinforcement of the two indirect waves may also occur even when there is only one obstacle. For example, as shown in FIG. 3B, when the ultrasonic waves transmitted by the sonars A and C are reflected by an obstacle 54 and are received by the sonar B as an indirect wave. In this case as well, affirmative determinations are made in steps S30 and S40, for example, and step S60 is executed, but positions of the obstacles are estimated to be the same position in step S60.

Although the present disclosure has been described in detail with reference to the specific embodiment, it will be apparent to those skilled in the art that the present disclosure is not limited to the above-described embodiment, and various other embodiments are possible within the scope of the present disclosure.

For example, in the above-described embodiment, the maximum values Yamax and Ybmax of the ratios Ya and Yb expressed by equations (1) and (2), respectively, are taken as predetermined magnifications. However, the predetermined magnification may be set to a value other than the maximum values Yamax and Ybmax.

In the embodiment, when an affirmative determination is made in step S30, step S40 is executed. However, when an affirmative determination is made in step S30, it may be determined whether or not the sonar B receives only one indirect wave; when an affirmative determination is made, step S40 may be executed; and when a negative determination is made, step S70 may be executed.

Similarly, when an affirmative determination is made in step S230, it may be determined whether or not the sonar C receives only one indirect wave; when an affirmative determination is made, step S240 may be executed; and when a negative determination is made, step S270 may be executed.

In the embodiment, although the front end sonars A to D and the rear end sonars E to H are provided, the front end sonars A to D or the rear end sonars E to H may be omitted.

In the embodiment, when the front end switch 12F is on, the front end sonars A to D are controlled, and when the rear end switch 12R is on, the rear end sonars E to H are controlled. However, when the vehicle 102 is in a preset driving state, the sonars may be controlled without requiring the operation of the switches.

Further, in the embodiment, the sonars transmit ultrasonic waves, but transmitted sound waves may have a lower frequency than the ultrasonic waves.

What is claimed is:

1. An object detection device for a vehicle, comprising first to third sonars arranged spaced from each other on an outer periphery of the vehicle with the third sonar being located between the first and second sonars, and a control unit for controlling the first to third sonars; the first and second sonars are configured to simultaneously transmit sound waves and receive direct waves that are sound waves reflected by objects; the third sonar is configured to receive indirect waves that are sound waves transmitted by the first and second sonars and reflected by the objects; and the control unit is configured to estimate positions of the objects that generate the direct waves and the indirect waves by reflection of the sound waves based on flight times of the direct waves and the indirect waves, wherein
the control unit is configured to, when, in a situation where the first and second sonars receive the direct waves and the third sonar receives one indirect wave, a peak value of the indirect wave received by the third sonar is greater than or equal to a predetermined magnification with respect to peak values of the direct waves received by the first and second sonars, estimate a position of an object existing in a detection area by the direct wave received by the first sonar based on the flight time of the direct wave received by the first sonar and the flight time of the indirect wave received by the third sonar, and estimate a position of an object existing in a detection area by the direct wave received by the second sonar based on the flight time of the direct wave received by the second sonar and the flight time of the indirect wave received by the third sonar.

2. The object detection device for a vehicle according to claim 1, wherein the control unit is configured to estimate a sonar corresponding to the indirect wave received by the third sonar among the first and second sonars, and estimate a position of the object existing in the detection area by the direct wave received by the estimated sonar based on the flight time of the direct wave received by the estimated sonar and the flight time of the indirect wave received by the third sonar.

3. The object detection device for a vehicle according to claim 1, wherein the first and second sonars are configured to transmit sound waves encoded in different codes by frequency modulation, and the control unit is configured to estimate a sonar corresponding to the indirect wave received by the third sonar based on the code of the indirect wave received by the third sonar.

4. The object detection device for a vehicle according to claim 1, wherein the control unit is configured to, when only one of the first and second sonars receives the direct wave and the third sonar receives the indirect wave, estimate a position of the object existing in the detection area by the direct wave received by the one of the first and second sonars based on the flight time of the direct wave received by the one of the first and second sonars and the flight time of the indirect wave received by the third sonar.

5. The object detection device for a vehicle according to claim 1, wherein with a range where the detection area by the direct wave received by the first sonar and a detection area by the indirect wave received by the third sonar overlap being defined as an overlapping range, and a ratio of a distance between an arbitrary point existing in the overlapping range and the third sonar to a distance between the arbitrary point and the first sonar being defined as a predetermined ratio, the predetermined magnification is a maximum value of the predetermined ratio.
